(19) United States
(12) Patent Application Publication
(10) Pub. No.: US 2023/0169399 A1
(43) Pub. Date: Jun. 1, 2023

(54) SYSTEM AND METHODS FOR ROBOTIC PROCESS AUTOMATION

(71) Applicant: BLUE PRISM LIMITED, Warrington (GB)

(72) Inventors: Jacques CALI, Warrington (GB); Krishna DUBBA, Warrington (GB); Ben CARR, Warrington (GB); Guillem CUCURULL, Warrington (GB); Umit Rusen AKTAS, Warrington (GB)

(21) Appl. No.: 17/922,675

(22) PCT Filed: May 1, 2020
(86) PCT No.: PCT/EP2020/062199

§ 371 Date: Nov. 1, 2022

(51) Int. Cl. G06N 20/00; G05B 13/02

(52) U.S. Cl. CPC G06N 20/00; G05B 13/0265

(57) ABSTRACT

There is disclosed a method of training an RPA robot to use a GUI. The method comprises capturing video of the GUI as an operator uses the GUI to carry out a process; capturing a sequence of events triggered as the operator uses the GUI to carry out said process; and analyzing said video and said sequence of events to thereby generate a workflow. The workflow, when executed by an RPA robot, causes the RPA robot to carry out said process using the GUI.

### FIELD OF THE INVENTION

The present invention relates to systems and methods for robotic process automation and, in particular, automatic training of robotic process automation robots.

### BACKGROUND OF THE INVENTION

Human guided computer processes are ubiquitous across many field of technology and endeavour. Modern graphical user interfaces (GUIs) have proven invaluable in allowing human operators to use computer systems to carry out often complex data processing and/or systems control tasks. However, whilst GUIs often allow human operators to quickly become accustomed to performing new tasks, they provide a high barrier to any further automation of tasks.

Traditional workflow automation aims to take tasks usually performed by operators using GUIs and automate them so that a computer system may carry out the same task without significant re-engineering of the underlying software being used to perform the task. Initially, this required exposing application programming interfaces (APIs) of the software so that scripts may be manually devised to execute the required functionality of the software so as to perform the required task.

Robotic process automation (RPA) systems represent an evolution of this approach and use software agents (referred to as RPA robots) to interact with computer systems via the existing graphical user interfaces (GUIs). RPA robots can then generate the appropriate input commands for the GUI to cause a given process to be carried out by the computer system. This enables the automation of processes, turning attended processes into unattended processes. The advantages of such an approach are multitude and include greater scalability allowing multiple RPA robots to perform the same task across multiple computer systems, along with a greater repeatability as the possibility for human error in a given process in reduced or even eliminated.

However, the process of training a RPA robot to perform a particular task can be cumbersome and requires a human operator to use the RPA system itself to program in the particular process specifically identifying each individual step using the RPA system. The human operator is also required to identify particular portions of the GUI to be interacted with, and to build a workflow for the RPA robot to use.

### SUMMARY OF THE INVENTION

The invention provides a method of training an RPA robot to perform task using a GUI based on just analysis of video of an operator using the GUI and the events (or input) triggered by the operator when carrying out the process. In this way the above problems of the prior art regarding the training of RPA robots may be obviated.

In a first aspect there is provided a method of training an RPA robot (or script or system) to use a GUI. The method comprises steps of capturing video of the GUI as an operator (or user) uses the GUI to carry out a process (or task); capturing a sequence of events triggered as the operator uses the GUI to carry out said process and analyzing said video and said sequence of events to thereby generate a workflow. The workflow is such that, when executed by an RPA robot, causes the RPA robot to carry out said process using the GUI. The steps of capturing may be carried out by a remote desktop system.

The step of analyzing may further comprise steps of identifying one or more interactive elements of the GUI from said video and matching at least one of the events in the sequence of events as corresponding to a least one of the interactive elements. An interactive element may be any typical GUI element such as (but not limited to) a text box, a button, a context menu, a tab, a radio button (or array thereof), a checkbox (or array thereof) etc. The step of identifying an interactive element may be carried out by applying a trained machine learning algorithm to at least part of the video.

Identifying an interactive element may comprise identifying positions of one or more anchor elements in the GUI relative to said interactive element. For example, a machine learning algorithm (such as a graph neural network) may be used to identify the one or more anchor elements based on one or more pre-determined feature values. Said feature values may also be determined via training of the machine learning algorithm.

Said feature values may include any one or more of: distance between elements, orientation of an element; and whether elements are in the same window.

The sequence of events may comprise any one or more of: a keypress event; a click event (such as a single click, or multiples thereof); a drag event; and a gesture event. Inferred events (such as a hoverover event) based on the video may also be included in the sequence of events. Typically, a hover event may be inferred based on one or more interface elements becoming visible in the GUI.

The step of analyzing may further comprise identifying a sequence of sub-processes of said process. In a sequence of sub-processes a process output of one of the sub-processes of the sequence may be used by the RPA robot as a process input to another sub-process of the sequence.

The generated workflow may be editable by a user to enable the inclusion of a portion of a previously generated workflow corresponding to a further sub-process, such that said edited workflow, when executed by an RPA robot, causes the RPA robot to carry out a version of said process using the GUI, the version of said process including the further sub-process. The version of said process may include the further sub-process in place of an existing sub-process of said process.

In a second aspect there is provided methods of carrying out a process using a GUI using an RPA robot trained by the methods according to the first aspect above. In particular said method may comprise the RPA robot re-identifying one or more interactive elements in the GUI based on respective anchor elements specified in a workflow. A machine learning algorithm (such as a graph neural network), may be used to re-identify the one or more interactive elements based on one or more pre-determined feature values (such as those determined as part of methods of the first aspect).

There is also provided systems and apparatus arranged to carry out any of the methods set out above. For example there is provided a system for training an RPA robot (or script or system) to use a GUI. The system is arranged to capture video of the GUI as an operator (or user) uses the GUI to carry out a process (or task) and capture a sequence of events triggered as the operator uses the GUI to carry out said process. The system further comprises a workflow generation module arranged to analyze said video and said sequence of events to thereby generate a workflow.

The invention also provides one or more computer programs suitable for execution by one or more processors such computer program(s) being arranged to put into effect the methods outlined above and described herein. The invention also provides one or more computer readable media, and/or data signals carried over a network, which comprise (or store thereon) such one or more computer programs.

### BRIEF DESCRIPTION OF THE DRAWINGS

Embodiments of the invention will now be described, by way of example only, with reference to the accompanying drawings, in which:

FIG. 1 schematically illustrates an example of a computer system;

FIG. 2 schematically illustrates a system for robotic process automation (RPA);

FIG. 3a is a flow diagram schematically illustrating an example method for training an RPA robot;

FIG. 3b is a flow diagram schematically illustrating an example method of an RPA robot of an RPA system executing a workflow to carry out a process;

FIG. 4 schematically illustrates an example workflow analysis module of an RPA system, such as the RPA system of FIG. 2;

FIG. 5 schematically illustrates a computer vision module such as may be used with the RPA system of FIGS. 2 and 4;

FIG. 6 schematically illustrates an action identification module such as may be used with the RPA system of FIGS. 2 and 4;

FIG. 7 schematically illustrates an example of a workflow and an edited version of the workflow;

FIG. 8 schematically illustrates an example execution module of an RPA system, such as the RPA system described in FIG. 2.

FIG. 9a shows an image from a video of a GUI;

FIG. 9b shows a further image from a video of a GUI having undergone a re-identification process.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

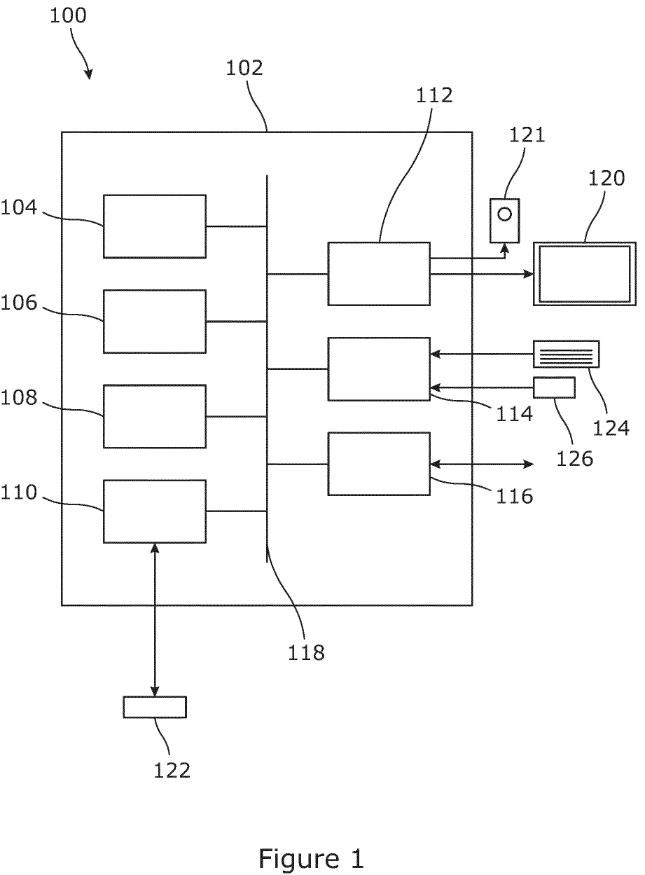

FIG. 1 schematically illustrates an example of a computer system 100. The system 100 comprises a computer 102. The computer 102 comprises: a storage medium 104, a memory 106, a processor 108, an interface 110, a user output interface 112, a user input interface 114 and a network interface 116, which are all linked together over one or more communication buses 118.

The storage medium 104 may be any form of non-volatile data storage device such as one or more of a hard disk drive, a magnetic disc, an optical disc, a ROM, etc. The storage medium 104 may store an operating system for the processor 108 to execute in order for the computer 102 to function. The storage medium 104 may also store one or more computer programs (or software or instructions or code).

The memory 106 may be any random access memory (storage unit or volatile storage medium) suitable for storing data and/or computer programs (or software or instructions or code).

The processor 108 may be any data processing unit suitable for executing one or more computer programs (such as those stored on the storage medium 104 and/or in the memory 106), some of which may be computer programs according to embodiments of the invention or computer programs that, when executed by the processor 108, cause the processor 108 to carry out a method according to an embodiment of the invention and configure the system 100 to be a system according to an embodiment of the invention. The processor 108 may comprise a single data processing unit or multiple data processing units operating in parallel or in cooperation with each other. The processor 108, in carrying out data processing operations for embodiments of the invention, may store data to and/or read data from the storage medium 104 and/or the memory 106.

The interface 110 may be any unit for providing an interface to a device 122 external to, or removable from, the computer 102. The device 122 may be a data storage device, for example, one or more of an optical disc, a magnetic disc, a solid-state-storage device, etc. The device 122 may have processing capabilities - for example, the device may be a smart card. The interface 110 may therefore access data from, or provide data to, or interface with, the device 122 in accordance with one or more commands that it receives from the processor 108.

The user input interface 114 is arranged to receive input from a user, or operator, of the system 100. The user may provide this input via one or more input devices of the system 100, such as a mouse (or other pointing device) 126 and/or a keyboard 124, that are connected to, or in communication with, the user input interface 114. However, it will be appreciated that the user may provide input to the computer 102 via one or more additional or alternative input devices (such as a touch screen). The computer 102 may store the input received from the input devices via the user input interface 114 in the memory 106 for the processor 108 to subsequently access and process, or may pass it straight to the processor 108, so that the processor 108 can respond to the user input accordingly.

The user output interface 112 is arranged to provide a graphical/visual and/or audio output to a user, or operator, of the system 100. As such, the processor 108 may be arranged to instruct the user output interface 112 to form an image/video signal representing a desired graphical output, and to provide this signal to a monitor (or screen or display unit) 120 of the system 100 that is connected to the user output interface 112. Additionally, or alternatively, the processor 108 may be arranged to instruct the user output interface 112 to form an audio signal representing a desired audio output, and to provide this signal to one or more speakers 121 of the system 100 that is connected to the user output interface 112.

Finally, the network interface 116 provides functionality for the computer 102 to download data from and/or upload data to one or more data communication networks.

It will be appreciated that the architecture of the system 100 illustrated in FIG. 1 and described above is merely exemplary and that other computer systems 100 with different architectures (for example with fewer components than shown in FIG. 1 or with additional and/or alternative components than shown in FIG. 1) may be used in embodiments of the invention. As examples, the computer system 100 could comprise one or more of: a personal computer; a server computer; a mobile telephone; a tablet; a laptop; a television set; a set top box; a games console; other mobile devices or consumer electronics devices; etc.

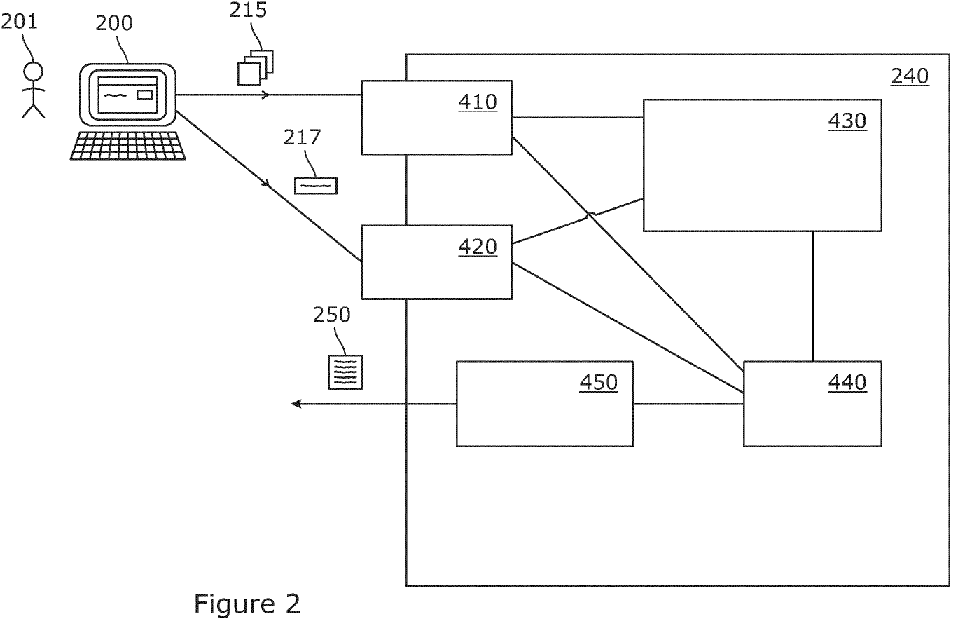

FIG. 2 schematically illustrates a system for robotic process automation (RPA). As depicted in FIG. 2, there is a computer system 200 (such as the computer system 100 described above) operated by an operator (or a user) 201. The computer system 200 is communicatively coupled to an RPA system 230.

The operator 201 interacts with the computer system 200 to cause the computer system 200 to carry out a process (or function or activity). Typically, the process carried out on the computer system 200 is carried out by one or more applications (or programs or other software). Such programs may be carried out or executed directly on the system 200 or may be carried out elsewhere (such as on a remote or cloud computing platform) and controlled and/or triggered by the computer system 200. The operator 201 interacts with the computer system 200 via a graphical user interface (GUI) 210 which displays one or more interactive elements to the operator 201. The operator 201 is able to interact with said interactive elements via a user input interface of the computer system 200 (such as the user input interface 114 described above). It will be appreciated that as the operator 201 interacts with the GUI 210 as displayed to the operator 201 typically changes to reflect the operator interaction. For example, as the operator inputs text into a textbox in the GUI 210 the GUI 210 will display the text entered into the text box. Similarly, as the operator moves a cursor across the GUI 210 using a pointing device (such as a mouse 126) the pointer is shown as moving in the GUI 210.

The RPA system 230 is arranged to receive video 215 of the GUI 210. The video 215 of the GUI 210 shows (or visually depicts or records) the GUI 210 displayed to the operator 201 as the operator 201 uses the GUI 210 to carry out the process. The RPA system 230 is also arranged to receive (or capture) a sequence of events 217 triggered in relation to the GUI by the operator using the GUI to carry out the process. Such events may include individual key presses made by the operator 201, clicks (or other pointer interaction events) made by the operator 201, events generated by the GUI itself (such as on click events relating to particular elements, changes of focus of particular windows in the GUI, etc.).

A workflow analysis module 240 of the RPA system 230 is arranged to analyse the video of the GUI 210 and the sequence of events 217 to thereby generate a workflow (or a script) for carrying out said process using the GUI 210. Workflows are described in further detail shortly below. However, it will be appreciated that a workflow 250 typically defines a sequence of interactions (or actions) with the GUI 210. The interactions may be inputs to be carried out on or in relation to particular identified elements of the GUI such that when the sequence of interactions is carried out on the GUI the system 200 on which the GUI is operating carries out said process. As such a workflow 250 may be thought of as being (or representing) a set of instructions for carrying out a process using a GUI.

An execution module 270 of the RPA system 230 is arranged to cause the workflow 250 to be carried out on the respective GUIs 210-1; 210-2;... of one or more further computer systems 200-1; 200-2;... In particular, the execution module 270 is arranged to receive video of the respective GUI 210-1; 210-2;... on the further computing systems 200-1; 200-2;.... The execution module 270 is also arranged to provide input 275 to the further computer systems 200-1 ; 200-2;... emulating input that an operator 201 would provide. By analysing the video of the respective GUIs the execution module is able to identify (or re-identify) the GUI elements present in the workflow 250 and provide inputs to the further GUIs in accordance with the workflow 250. In this way the execution module may be considered to be an RPA robot (or software agent) operating a further system 200-1, via the respective GUI, 210-1 to carry out the process. It will be appreciated that the further systems 200-1; 200-2;... may be systems such as system 200 such as the computer system 100 described above. Alternatively one or more of the further computing systems 200-1; 200-2;... may be virtualized computer systems. It will be appreciated that multiple instances of the execution module 270 (or RPA robot) may be instantiated by the RPA system 230 in parallel (or substantially in parallel) allowing multiple instances of the process to be carried out substantially at the same time on respective further computing system 200-1; 200-2;....

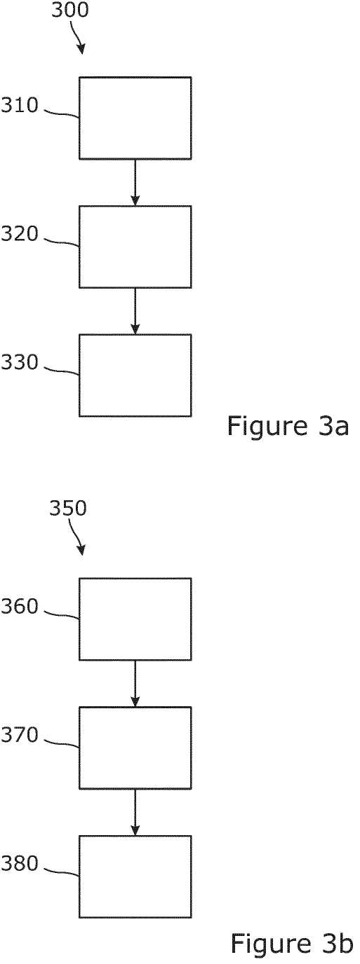

FIG. 3a is a flow diagram schematically illustrating an example method 300 for training an RPA robot according to the RPA system 230 of FIG. 2.

At a step 310 video 215 of a GUI 210 as an operator 201 uses the GUI 210 to carry out a process is captured.

At a step 320 a sequence of events 217 triggered as the operator 201 uses the GUI 210 to carry out said process is captured.

At a step 330 a workflow is generated based on the video 215 and the sequence of events 217. In particular, the video 215 and the sequence of events 217 analyzed to thereby generate the workflow which, when executed by an RPA robot, causes the RPA robot to carry out said process using the GUI. The video 215 and the sequence of events 217 may be analyzed using one or more trained machine learning algorithms. The step 330 may comprise identifying one or more interactive elements of the GUI from said video and matching at least one of the events in the sequence of events as corresponding to a least one of the interactive elements. In this way the step 330 may comprise identifying a sequence of interactions for the workflow.

FIG. 3b is a flow diagram schematically illustrating an example method 350 of an RPA robot of an RPA system 230 executing a workflow 250 to carry out a process. The RPA system 230 may be an RPA system 230 according as described above in relation to FIG. 2.

At a step 360 video of a GUI 210-1 on a computing system 200-1 is received.

At a step 370 video of a GUI 210-1 on a computing system 200-1 is received.

At a step 380 input 275 is provided to the computer system 200-1 based on the workflow 250. The step 380 may comprise analysing the video of the GUI to re-identify) the GUI elements present in the workflow 250 and provide input to the GUI in accordance with the workflow 250. In this way the step 380 may operate a further system 200-1, via the GUI to carry out the process.

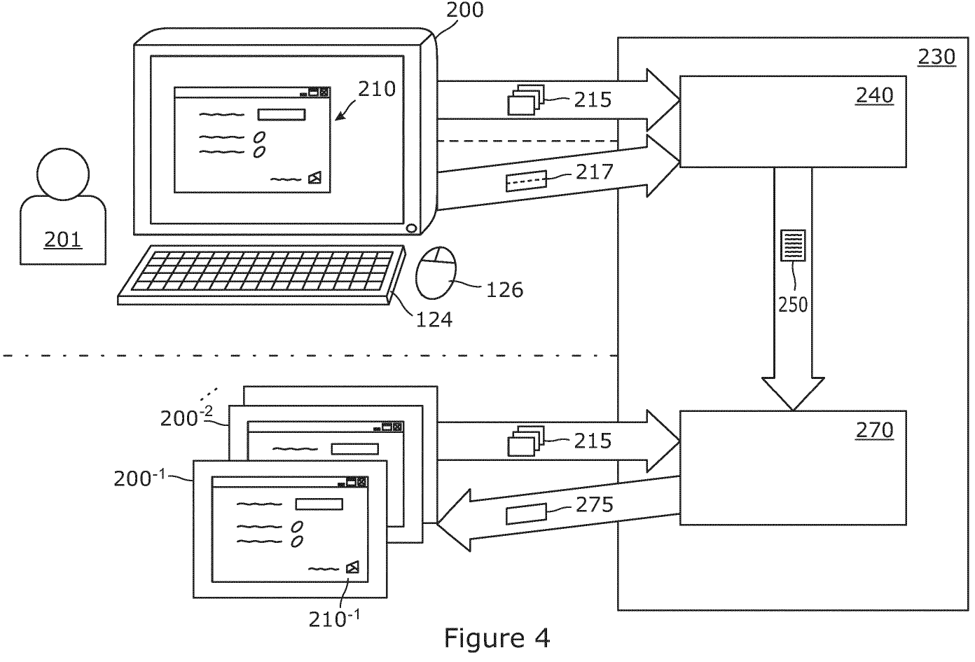

FIG. 4 schematically illustrates an example workflow analysis module of an RPA system, such as the RPA system 230 described above in relation to FIG. 2.

The workflow analysis module 240 shown in FIG. 4 comprises a video receiver module 410, an event receiver module 420, a computer vision module 430, an action identification module 440 and a workflow generation module 450. Also shown in FIG. 4 is an operator 201 interacting with a computer system 200 by way of a GUI 210, as described above in relation to FIG. 2.

The video receiver module 410 is arranged to receive (or capture or otherwise obtain) video 215 of the GUI 210. The video 215 of the GUI 210 may be generated on (or by) the computer system 200. The resulting video 215 may then be transmitted to the RPA system 230 (and thereby to the video receiver module 410) via a suitable data connection.

It will be appreciated that the computer system 200 may be connected to the RPA system 230 by a data connection. The data connection may be make use of any data communication network suitable for communicating or transferring data between the computer system 200 and the RPA system 230. The data communication network may comprise one or more of: a wide area network, a metropolitan area network, the Internet, a wireless communication network, a wired or cable communication network, a satellite communications network, a telephone network, etc. The computer system 200 and the RPA system 230 may be arranged to communicate with each other via a data communication network via any suitable data communication protocol. For example, when the network data communication comprises the Internet, the data communication protocol may be TCP/IP, UDP, SCTP, etc.

In a similar manner the computer system 200 may be arranged to forward (or otherwise transmit) the visual display of the GUI 210 to the video receiver module 410. The video receiver module may be configured to generate (or capture) the video 215 from the forwarded visual display of the GUI. Forwarding of the visual display of GUIs is well known and not discussed further herein. Examples of such forwarding include the X11 forwarding system available for the X11 windowing system, the Microsoft Corporation’s Remote Desktop Services available for Windows operating systems, and so on. Framebuffer type forwarding systems, such as those suing the remote frame buffer protocol are also suitable. Examples of such systems include the open source Virtual Network Computing (VNC) and its variants.

Additionally, or alternatively, the video receiver module 410 may be arranged to receive the image/video signal generated by the output interface 112. The image/signal may be received from a hardware device in the image/signal path between a user output interface 112 of the computer system 200 and a monitor 120 of the computer system 200. The video receiver module 410 may be configured to generate (or capture) the video 215 from the received image/video signal.

It will be appreciated that some of the functionality of the video receiver module 410 may be carried out on (or by) the computer system 200. In particular, the computer system 200 may execute a piece of software (or software agent) arranged to generate the video 215 of the GUI 210.

The event receiver module 420 is arranged to receive (or capture) a sequence of events 217 triggered in relation to the GUI by the operator using the GUI to carry out a process. An event may be (or comprise) an input to the computer system 200. In particular, an event may comprise any of a pointer (such as a mouse pointer) click, a pointer drag, pointer movement, a key press (such as via a keyboard, or a display-based soft keyboard), scroll wheel movement, a touch screen (or pad) event (such as a drag or click or gesture etc.), joystick (or d-pad) movement, and so on and so forth.

It will be understood that an event may comprise more than one inputs. For example, multiple simultaneous key presses (such as the use of a control and/or alternate, or other modifier key) may be recorded as a single event. Similarly, inputs grouped within a threshold time (such as a double or triple click) may be recorded as a single event. An event typically also comprises metadata. The metadata for an event may comprise: a pointer (or cursor) location on the screen at the time of the event; the key (in the case of a key press), etc.

In a similar manner to the video receiver module 410, the computer system 200 may be arranged to forward (or otherwise transmit) events triggered by the operator in relation to the GUI 210 to the event receiver module 420. The event receiver module 420 may be configured to generate (or capture) the received events in sequence. Forwarding of input events is well known and not discussed further herein. Examples of such forwarding include the X11 forwarding system available for the X11 windowing system, the Microsoft Corporation’s Remote Desktop Services available for Windows operating systems, the open source Virtual Network Computing (VNC) and its variants. Typically, such forwarding systems involve executing a software agent (or helper program) on the computer system 200 which captures the events at the operating system level. In some cases, such as the Microsoft Remote Desktop Services and the X11 forwarding system the forwarding system is part of the operating system.

Additionally, or alternatively, the event receiver module 420 may be arranged to receive the input signal generated by the one or more input devices 124; 126. The input signal may be received from a hardware device in the input signal path between the one or more input devices 124; 126 and a user input interface 114 of the computer system 200. Such hardware devices (such as key loggers) are well known and not described further herein. The event receiver module 420 may be configured to generate (or capture) the sequence of events 217 from the received input signal.

The computer vision module 430 is arranged to identify elements of the GUI 210 (commonly referred to as graphical user interface elements) from a video 215 of the GUI. The computer vision module 430 may be arranged to use image analysis techniques, such as feature detection to identify GUI elements based on known configurations (or appearances) of expected GUI elements. Additionally, or alternatively the computer vision module 430 may be arranged to use a machine learning algorithm trained to identify particular GUI elements. The computer vision module 430 may be arranged to use optical character recognition techniques to identify text components of identified GUI elements. Standard object detection techniques may be used in such identification. For example, a Mask-RCNN approach may be used, as set out in “MASK R-CNN”, Kaiming He, Georgia Gkioxari, Piotr Dollar, Ross Girshick, IEEE Transactions on Pattern Analysis and Machine Intelligence 2020, DOI: 10.1 109/TPAMI.2018.2844175 the entire contents of which is herein incorporated by reference.

Additionally or alternatively such techniques may use machine learning, such as deep learning models, to detect GUI elements. Such deep learning models may be trained using training data comprising annotated screenshots (or parts thereof) of GUI elements. In particular the annotations may comprise bounding boxes used to identify the known GUI elements in a given screenshot.

The computer vision module 430 is further arranged to identify one or more anchor GUI elements for a given identified GUI element. The computer vison module 430 is also arranged to associate the one or more anchor elements with the given identified GUI element. As described shortly below, an anchor element may be identified for a given element based on expected co-occurring GUI elements. The anchor elements are typically identified for a given GUI element to enable the computer vision module 430 to re-identify a given element should the position (or arrangement) of the given GUI element change due to a change in the GUI.

The action identification module 440 is arranged to identify one or more actions carried out by the operator 201 on the GUI 210. In particular, the action identification module 440 is arranged to identify an action based on the sequence of events 217 and the GUI elements identified by the computer vision module 430. Typically, an action comprises an input applied to one or more GUI elements. For example, an action may be any of: a pointer click on a GUI element (such as a button or other clickable element); text entry into a text box; selection of one or more GUI elements by a drag event; and so on and so forth.

The action identification module 440 is typically arranged to identify an action by matching one or more events in the sequence of events 217 to one or more identified GUI elements. For example, a pointer click even having a pointer location coincident with a clickable GUI element (such as a button) may be identified as an action where the GUI element has been clicked. Similarly, one or more keypress events occurring when a cursor is present in an identified textbox may be identified as an action where text is input into the textbox. Additionally, or alternatively, events such as click events occurring not within a GUI element may be disregarded.

The workflow generation module 450 is arranged to generate a workflow 250 based on the actions identified by the action identification module 440. As discussed above a workflow 250 defines a sequence of interactions with the GUI 210. Each interaction (or step) of the workflow typically defines an input (or inputs) to be triggered and a GUI element to be acted upon. For example, an interaction may be the clicking of a button, where the interaction may then specify the button to be clicked (i.e. the GUI element) and the type of click (right or left for example). An interaction (or step) also specifies (or defines or otherwise indicates) the anchor elements for the GUI element to be acted upon, so as to enable re-identification of the GUI element when the workflow is executed as described shortly below.

In this way it will be understood that the workflow 250 so generated enables an execution system (or RPA robot), as described shortly below, to carry out a process using a GUI. In other words, the workflow analysis module, by way of the generated workflow 250, is arranged to train a given RPA robot to carry out a process based on observation of a human operator 201 carrying out said process using a GUI 210.

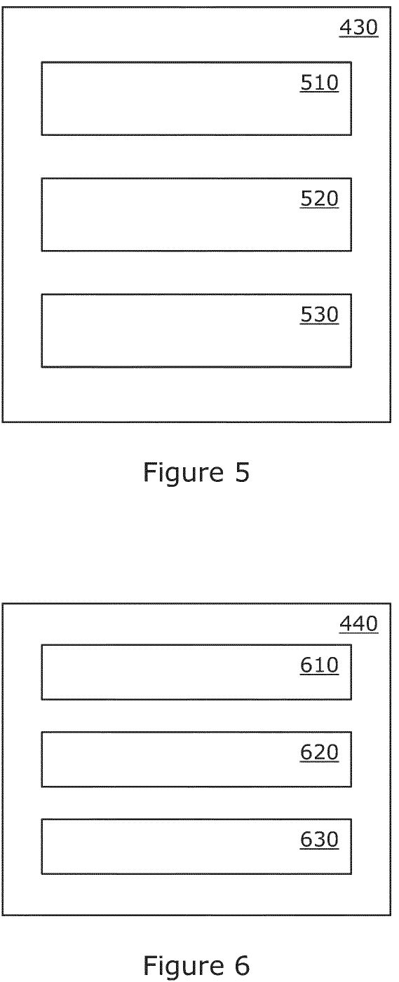

FIG. 5 schematically illustrates a computer vison module 430 such as the computer vision module discussed above in relation to FIG. 4.

The computer vision module 430 comprises a representative frame identification module 510, a GUI element identification module 520, and an event identification module 530.

The representative frame identification module 510 is arranged to identify representative frames (or images) in a video 215 of a GUI. A representative frame may be identified as a frame depicting the GUI in particular state. It will be understood that typically as an operator 201 interacts with a GUI 210 the GUI 210 changes state with the display of the GUI changing to reflect the new state. For example, a new window may be displayed with new GUI (or interface) elements, a dialog box may be displayed, etc. Equally, GUI (or interface) elements may be removed for example dialog boxes may disappear once the operator has interacted with them, a new tab may be selected replacing the display of the old tab with the new tab, etc. In this way it will be understood that representative frames may be identified based on changes to the displayed GUI.

The representative frame identification module 510 may be arranged to identify representative frames by applying video analysis techniques to identify frames or images in the video that are above a threshold level of visual difference to the frame (or frames) preceding them. Additionally, or alternatively, the representative frame identification module 510 may be arranged to identify representative frames based on identifying new interface elements present in a given frame that were not present in previous frames. The identification of GUI elements may be carried out by the GUI element identification module 520 described shortly below.

The representative frame identification module 510 may be arranged to use a suitable trained machine learning algorithm (or system) to identify representative frames. Here the machine learning algorithm would be trained to identify GUI state changes based on video of a GUI. In particular the machine learning algorithm may classify a frame (or image) from the video of the GUI as a representative frame based on a change to the visual appearance of the frame with respect to adjacent (or nearby) frames in the video. Such classification may also be based on correlation (or co-occurrence) of such a change in visual appearance with an input event to distinguish between changes in appearance that are due to user interaction, and changes that are not.

The GUI element identification module 520 is arranged to identify one or more GUI (or interface) elements in a GUI. In particular, the GUI element identification module 520 is arranged to identify a GUI element from an image of frame of a video 215 of a GUI, such as a representative frame identified by the representative frame identification module 510. The GUI element identification module 520 may be arranged to use image analysis techniques, such as feature detection to identify GUI elements based on known configurations (or appearances) of expected GUI elements. Additionally, or alternatively the GUI element identification module 520 may be arranged to use a machine learning algorithm trained to identify particular GUI elements.

Additionally, the GUI element identification module 520 may be arranged to identify and/or associate one or more anchor elements with a given identified GUI element. The anchor GUI elements for a given GUI element may be identified based on a proximity (or distance) to the given identified element. In particular, a GUI element may be identified as an anchor element if placed within a pre-determined distance of the given GUI element. Additionally, or alternatively an anchor element may be identified as an anchor element based on type of the anchor element and the given element. For example, if the given GUI element is a text box a text label may be expected to be present close to the text box. As such a label GUI element may be identified as an anchor element for the text box GUI element. Equally, if the given GUI element is a radio button element further radio button elements may be expected to be present close to the identified radio button. It will be appreciated that other methods for identifying anchor elements may also be used instead of, or in addition to, those described above. Such method may include any combination of: identifying a predetermined number of nearest elements as anchor elements (a k-nearest neighbours approach), identifying nearest elements in one or more predetermined directions as anchor elements, identifying all elements within a certain predefined region of the given identified element as anchor elements, etc.

The GUI element identification module 520 is further arranged to re-identify a GUI element (such as a GUI element previously identified by the GUI element identification module 520) identified in a further image (or frame) of a video 215 (or further video) of a GUI. In particular the GUI element identification module 520 is arranged to determined that a GUI element identified in a further image corresponds to a previously identified GUI element from a previous image based on anchor elements associated with the previously identified GUI element. The GUI element in the further image may be re-identified based on identifying anchor elements of the GUI element in the further image that correspond to the same anchor elements of the previously identified GUI element. An anchor element may be considered to correspond to another anchor element if the relative positons of the anchor elements to their respective identified GUI elements is within a pre-determined threshold. Similarly if an identified GUI element is associated with a plurality (or set) of anchor elements then the set of anchor elements may be considered to correspond to another set of anchor elements if the relative positons of the sets of anchor elements to their respective identified GUI elements agree to within a pre-determined threshold. It will be appreciated that anchor elements may have an associated weight (or importance) with the relative positons higher weighted anchor elements being required to agree to whiting a smaller pre-determined threshold.

In this way it will be appreciated that the GUI element identification module can re-identify the same GUI input element, such as a particular input field in a GUI, in videos of subsequent instances of the GUI. The use of anchor elements provides that this re-identification may still take place even if the GUI is modified such that the GUI element changes position. This is because co-occurring GUI elements (anchor elements) such as labels for text boxes which are also likely to have been moved can be used to re-identify the GUI element.

The GUI element identification module module 520 may be arranged to use a suitable trained machine learning algorithm (or system) to re-identify GUI elements based on their respective anchor elements. For example, a graph neural network may be used as part of the machine learning algorithm. Here the GUI elements are mapped to (or represented) by nodes in a graph. The connections between nodes have different feature values that depend on the two nodes. Such feature values may include any one or more of: the distance between the two nodes, the orientation (or pose) of the nodes, whether nodes belong to same panel in the application window etc. The graph neural network may then be trained by optimizing on re-identifying nodes. In effect the graph neural network, through the training process, learns which features values are important for re-identification. In this way the GUI element identification module may take account of this when identifying anchor elements initially, selecting anchor elements that are more effective for re-identification.

It will be appreciated that the GUI element identification module 520 may be arranged to use a graph neural network as part of the machine learning algorithm to identify anchor elements initially for a given element in a similar manner. In particular elements may be identified as anchor elements based on feature values as discussed above.

The event identification module 530 is arranged to identify further events based on the video 215 of the GUI. Whilst the events described herein above relate to events triggered by (or otherwise involving) input from the operator 201 it will be appreciated that other events may occur based on inactivity of the operator or based on external triggers. For example, hovering a pointer over an interactive element may be thought of as a hoverover event which may trigger the display of one or more further GUI element (such as a context menu). As this is caused by inactivity, i.e. the operator not moving the pointer for a predetermined period of time such an event may not appear in the sequence of events 217 captured by the event receiver module 420. Additionally, or alternatively inactivity may be used to identify dynamic content (or elements), such as adverts. This may be done based on determining page loading events such as when a web page has finished loading. The event identification module 530 may be arranged to identify a further event based on identifying the appearance (or materialization or display) of one or more further GUI elements in the GUI at a point where there are no corresponding events in the sequence of events 217 captured by the event receiver module 420. The event identification module 530 may be arranged to use a suitable trained machine learning algorithm (or system) to identify further events based on the video 215 of the GUI. The event identification module 530 may also be arranged to distinguish between events that have similar user input. For example, user input of dragging the mouse can relate to a number of different interactions. These interactions may depend on the GUI element (or elements) identified. For example user input of dragging the mouse can relate to: dragging a slider, drag and drop of element, selecting elements within an area created by dragging (known as lassoing). They all have similar input events captured: mouse left button press, move mouse and release mouse left button but semantically different functionality. The event identification module 530 may be arranged to distinguish these events based on matching input with identified GUI elements. In particular the event identification module 530 may use heuristics or a trained machine learning classification model.

The event identification module 530 is typically arranged to include the identified further events in the sequence of events 217 for further processing by the action identification module 440.

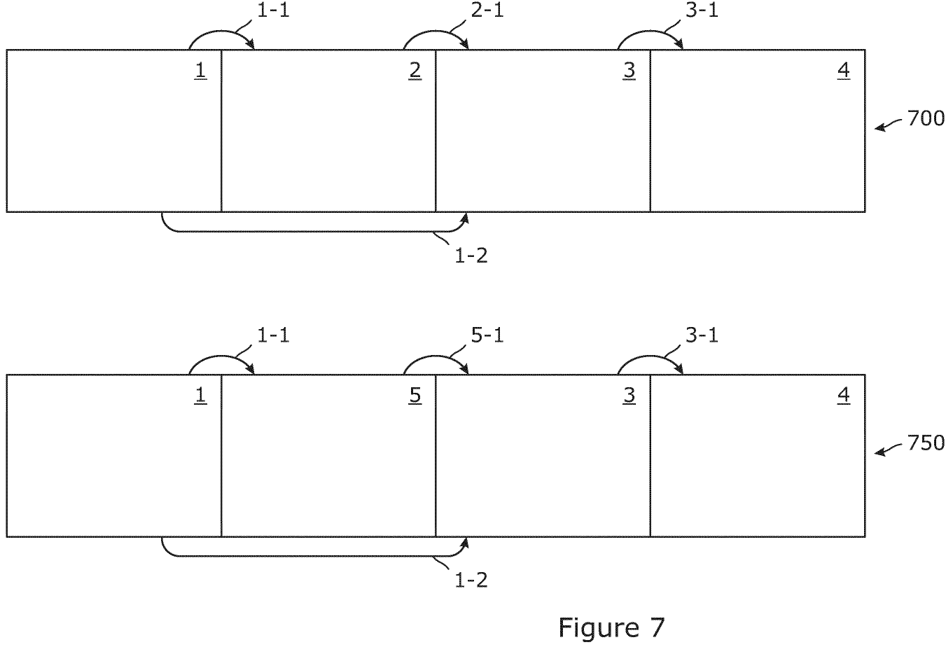

FIG. 6 schematically illustrates action identification module 440 such as the action identification module 440 discussed above in relation to FIG. 4.

The action identification module 440 comprises an event matching module 610, a sub-process identification module 620, and an input/output identification module 630.

The event matching module 610 is arranged to identify an action by matching one or more events in the sequence of events 217 to one or more identified GUI elements, as discussed above. For example the event matching module 610 may pair the events and the corresponding identified GUI elements that were acted upon. This may be done by matching the spatial co-ordinates of event (such as mouse click) and the GUI element at that location on the screen. For events that do not have spatial coordinates (such as keyboard actions) a previous event with spatial co-ordinates such as a mouse click may be used to pair the GUI element and the event. Additionally, or alternatively the location of a specific identified GUI element, such as a text cursor (or other input marker) may be used to pair an event (such as a key press) with a respective GUI element (such as a text box).

The sub-process identification module 620 is arranged to identify one or more sub-processes. It will be appreciated that a given process carried out by an operator 201 using a GUI 210 may be decomposed into separate sub-processes. Typically, a process may involve more than one discrete tasks, each a carried out by one or more sets of applications. For example, for a process of submitting an expense claim there may be a first sub-process of acquiring the requisite invoice using a first application, as a second sub-process the invoice may then need to be uploaded to an internal accounting platform, finally as a third sub-process the expenses application may be used to generate the claim itself. As such, the sub-process identification module 620 may be arranged to identify a sub-process as the sequence of events 217 corresponding to a particular application. The application (and the use of the application) may be identified based on the GUI elements identified by computer vision module 430. For example, the events triggered during a period when a particular application’s window was in focus may be identified as a sub-process. In one example a sub-process may be identified as all events triggered on a particular window when in focus and/or all events triggered on a window whilst the GUI elements for that window do not change more than a predetermined threshold. By identifying events triggered on a window whilst the GUI elements for that window do not change more than a predetermined threshold a sub-process can be identified for example in relation to a particular tab on a tabbed window. Here moving between tabs might cause a threshold number of elements (or more) to change (e.g. shift positon, be added or be removed). It will be appreciated that other such heuristic approaches (or criteria) may also be used.

The input/output identification module 630 is arranged to identify one or more process inputs. It will be appreciated that in carrying out a given process an operator 201 may us the GUI to input data (or process inputs). For example, an operator 201 may enter (or input) a username and/or password into the GUI as part of a process. The input/output identification module 630 may be arranged to store the input data in a data store 810 described shortly below (such as a data storage device 122 described above).

The input/output identification module 630 may be arranged to identify the process input as an action requiring the input data to be retrieved from the storage 810.

The input/output identification module 630 may be arranged to identify one or more process inputs and/or process outputs for a sub-process. It will be appreciated that a sub-process may provide an output (or process output) which may be used as a process input to a further sub-process. A process output may comprise data displayed via the GUI. For example, in the first sub-process described above may involve viewing the retrieved invoice so that an invoice number can be copied to a clipboard. The third sub-process may then involve pasting this invoice number into an expense claim form. In this way a process output of the first sub-step will be the invoice number copied to the clipboard. This invoice number in the clipboard will then serve as the process input for the third sub-step.

In other words where there is an input for a subprocess (such as a username and/or password etc) a user may be provided with an option for the input to specify a source (such as datastore, clipboard, file etc) to be used for the input.

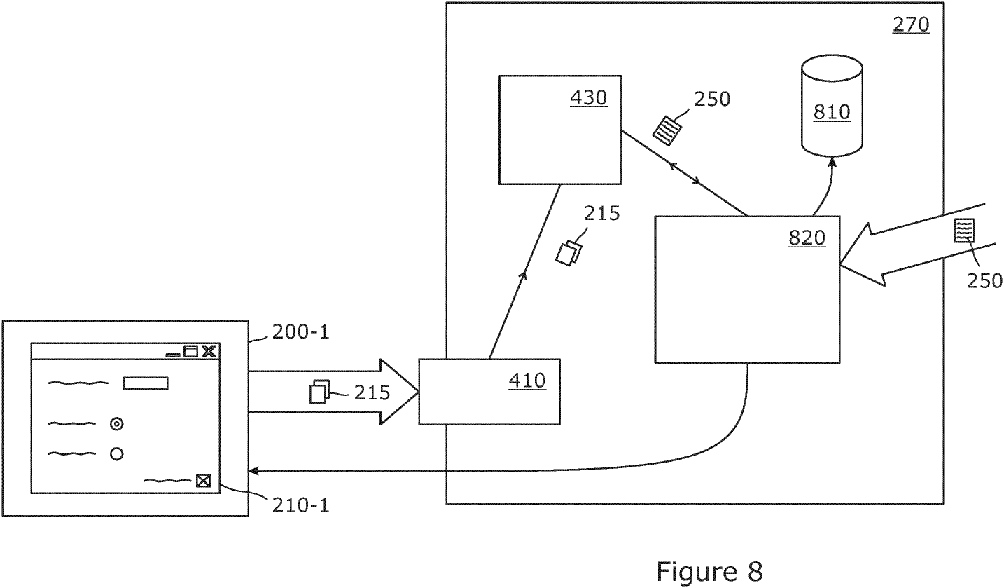

FIG. 7 schematically illustrates an example workflow 700. Also shown in FIG. 7 is an edited version 750 of the workflow.

The workflow 700 comprises four sub-processes 1, 2, 3, 4 having process inputs and process outputs as described above. The sub-process 1 has two process outputs 1-1; 1-2. The first process output 1-1 is a process input for the sub-process 2. The second process output 1-2 is a process input for the sub-process three. The sub-process 2 has a process output 2-1 which is a process input for sub-process 3. Similarly the sub-process 3 has a process output 3-1 which is a process input for sub-process 4.

It will be appreciated that the task carried out by a sub-process may be carried out equally be a different sub-process. The different sub-process may be one that forms part of a different workflow. For example, for the process of submitting an expense claim discussed above there may be a change of internal accounting platform. This may require that the second sub-process be changed so as to use the new platform. This can be achieved without re-recording (or regenerating) the workflow by instead substituting a new sub-process using the new accounting platform in the existing workflow to generate an edited version of the workflow.

The edited version 750 of the workflow comprises the sub-processes 1, 2, 4 of the workflow 700 but with the second sub-process 2 substituted for a further sub-process 5. This was possible as the further sub-process had the same process inputs and process outputs as the second sub-process. As can be seen the first process output 1-1 is now a process input for the further sub-process. The further sub-process 5 has a process output 5-1 which is a process input for sub-process 3.

It will be appreciated that in this way workflows may be changed and or combined to form a new workflow, performing a new process, without the new process having been carried out by an operator 201.

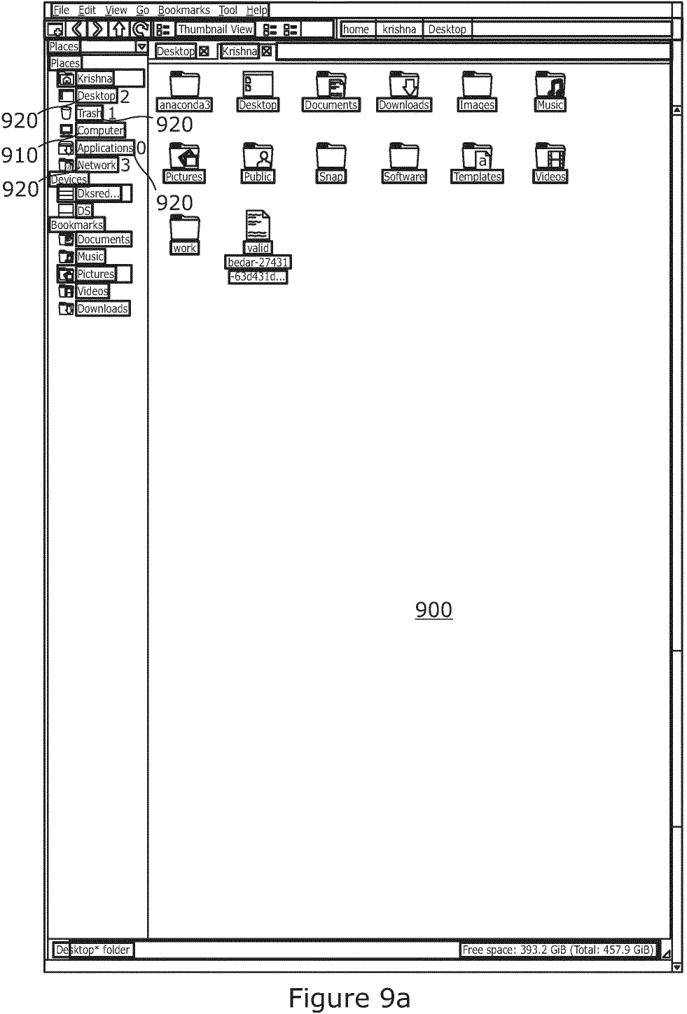

FIG. 8 schematically illustrates an example execution module 270 of an RPA system, such as the RPA system 230 described above in relation to FIG. 2.

The execution module 270 shown in FIG. 8 comprises a video receiver module 410, a computer vision module 430, a data storage 810 (such as a data storage device 122 described above), and an input trigger module 820. Also shown in FIG. 8 is a computer system 200-1 having a GUI 210-1.

It will be appreciated that the above descriptions of the video receiver module 410 and the computer vision module 430 apply equally to the video receiver module 410 and the computer vision module 430 depicted in FIG. 8. In particular, it will be appreciated that the computer vision module 430 is arranged to receive the video 215 of the GUI 210 from the video receiver module 410.

As shown in FIG. 8 the execution module 270 receives (or has loaded) a workflow 250 as described previously. This serves to train (or otherwise enable) the execution module 270 to use the GUI of the computer system 200-1 to carry out the process of the workflow 250.

The input trigger module 820 is arranged to generate input signals to the computer system 200 to carry out the interactions specified in the workflow. In particular, for a given interaction the input trigger module 820 is arranged to use the computer vision module 430 to re-identify the GUI element specified in the interaction. The input trigger module is arranged to generate input to carry out the interaction based on the re-identified GUI element. For example, were the interaction to specify a pointer click on a particular button the input trigger module would generate a pointer movement and click such that the click occurred in the location of the button as re-identified by the computer vision module. Thus any displacement of the button in the GUI relative to the positon of the button when the workflow was generated would be accounted for.

The input trigger module 820 may also be arranged to retrieve specific text input for an interaction from an external source, such as the data storage 810. The data storage may be arranged to store specific textual input for specific steps (or interactions) of the workflow. Examples of such specific textual input may include: a username and/or a password; pre-defined ID number or codes; etc. The data storage may be secured to ensure the confidentiality of the data stored thereon. In this way sensitive input (such as user names and passwords) may be protected and/or changed for future executions of the process as required.

It will be therefore appreciated that by iterating over the interactions in the workflow the execution module 270 may carry out the process of the workflow via the GUI. In this way the execution module 270 would be understood to be an RPA robot trained to carry out the process.

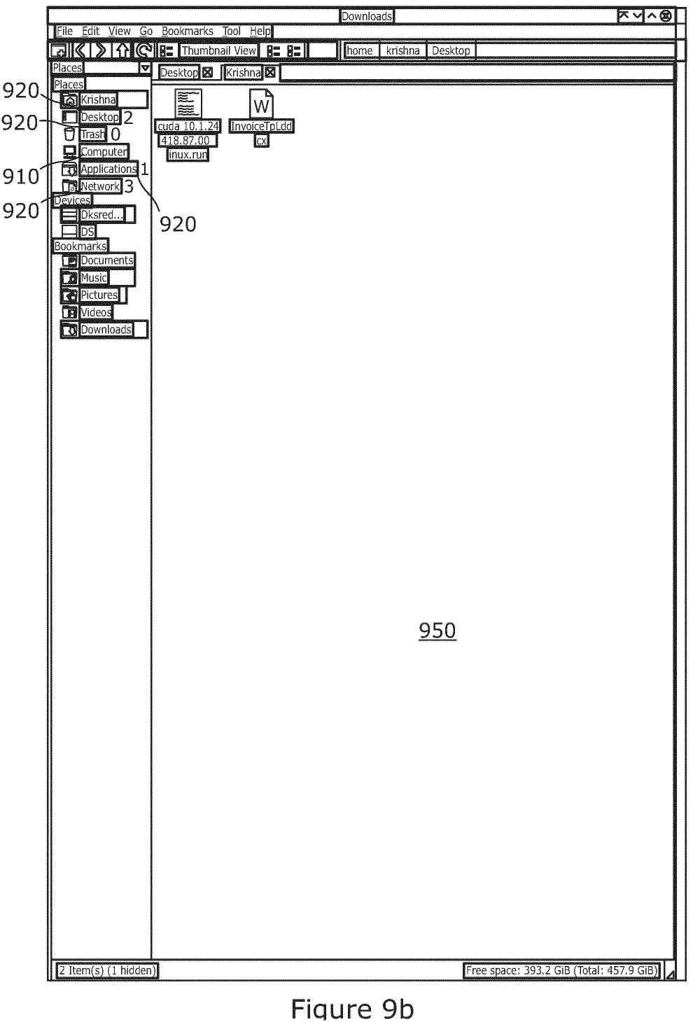

FIG. 9a shows an image 900 (or frame) from a video 215 of a GUI. A number of GUI elements have been identified by the GUI element identification module 520, as described previously. The identified GUI elements are indicated in the figure with boxes for the purposes of the figure. As can be seen from FIG. 9a the identified GUI elements include icons, text labels, tabs, menu items (buttons) and the like.

In particular, a particular GUI element 910 (the menu item “Computer” in the FIG. 9a) has been identified and four associated anchor elements 920 have also been identified. The identification of the anchor elements is as described previously above and is to allow for re-identification of the particular GUI element 910. In this example, the anchor elements have been chosen by the GUI element identification module based on the k-nearest neighbours. In this case k is equal to 4 here. This can be understood has prioritizing proximity as a feature value. However orientation of the anchor elements with respect to each other and/or the identified element may also be used - i.e. is the anchor box is not just near the candidate but also at the same orientation/direction.

FIG. 9b shows an image 950 (or frame) from a further video 215 of the GUI of FIG. 9a. In the image 950 a number of elements of the GUI are different with respect to the image 900 shown in FIG. 9. Again a number of GUI elements have been identified by the GUI element identification module 520, as described previously. The identified GUI elements are indicated in the figure with boxes. As can be seen from FIG. 9a the identified GUI elements include icons, text labels, tabs and the like.

In the image 950 the particular GUI element 910, identified in FIG. 9a, has be re-identified by the GUI element identification module 520, as described previously, based on the identified anchor elements 920. In this way the particular element 910 is re-identified despite changes to the GUI.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of training a robotic process automation (RPA) robot to use a graphical user interface (GUI), the method comprising:
capturing video of the GUI as an operator uses the GUI to carry out a process;
capturing a sequence of events triggered as the operator uses the GUI to carry out said process;
analyzing said video and said sequence of events to thereby generate a workflow which, when executed by an RPA robot, causes the RPA robot to carry out said process using the GUI.

2. The method of claim 1 wherein said analyzing further comprises:
identifying one or more interactive elements of the GUI from said video; and
matching at least one of the events in the sequence of events as corresponding to a least one of the interactive elements.

3. The method of claim 2 wherein identifying an interactive element is carried out by applying a trained machine learning algorithm to at least part of the video.

4. The method of claim 3 wherein identifying an interactive element comprises identifying positions of one or more anchor elements in the GUI relative to said interactive element.

5. The method of claim 4 wherein a machine learning algorithm is used to identify the one or more anchor elements based on one or more pre-determined feature values.

6. The method of claim 5 wherein the feature values are determined via training of the machine learning algorithm.

7. The method of claim 5 wherein the feature values include any one or more of:
distance between elements;
orientation of an element; and
whether elements are in the same window.

8. The method of claim 1 wherein the sequence of events comprise any one or more of:
a keypress event;
a hoverover event;
a click event;
a drag event; and
a gesture event.

9. The method of claim 8 comprising including based on the video one or more inferred events included in the sequence of events.

10. The method of claim 9 wherein a hover event is inferred based on one or more interface elements becoming visible in the GUI.

11. The method of claim 1 wherein the step of analyzing comprises:
identifying a sequence of sub-processes of said process.

12. The method of claim 11 wherein a process output of one of the sub-processes of the sequence is used by the RPA robot as a process input to another sub-process of the sequence.

13. The method of claim 12 further comprising editing the generated workflow to include a portion of a previously generated workflow corresponding to a further sub-process, such that said edited workflow, when executed by an RPA robot, causes the RPA robot to carry out a version of said process using the GUI, the version of said process including the further sub-process.

14. The method of claim 13 wherein the version of said process includes the further sub-process in place of an existing sub-process of said process.

15. The method of claim 1 wherein the video and or the sequence of events are captured using a remote desktop system.

16. A method of carrying out a process using a GUI using an RPA robot trained by the method according to claim 1.

17. The method of claim 16 further comprising the RPA robot re-identifying one or more interactive elements in the GUI based on respective anchor elements specified in a workflow.

18. The method of claim 17 wherein a machine learning algorithm is used to re-identify the one or more interactive elements based on one or more pre-determined feature values.

19. The method of claim 18 wherein the feature values are determined via training of the machine learning algorithm.

20. The method of claim 18 wherein the feature values include any one or more of:
distance between elements;
orientation of an element; and
whether elements are in the same window.

21. An apparatus arranged to carry out a method according to claim 1.

22. A computer program which, when executed by a processor, causes the processor to carry out a method according to claim 1.

23. A computer-readable medium storing a computer program_which, when executed by a processor, causes the processor to carry out a method according to claim 1.
